(19) United States
(12) Patent Application Publication
(10) Pub. No.: US 2026/0129371 A1
(43) Pub. Date: May 7, 2026

(54) AUDIO DEVICE WITH FLEXIBLE BEAMS

(71) Applicant: TEXAS INSTRUMENTS INCORPORATED, Dallas, TX (US)

(72) Inventors: Bichoy Bahr, Allen, TX (US); Udit Rawat, Allen, TX (US)

(21) Appl. No.: 18/935,318

(22) Filed: Nov. 1, 2024

(51) Int. Cl. H04R 9/08

(52) U.S. Cl. CPC H04R 9/08

(57) ABSTRACT

An apparatus is described which comprises a substrate having a through opening and a membrane over the through opening. In at least one example, the apparatus comprises a first beam coupled between a first side of the membrane and the substrate, the first beam including a first stress sensor. In at least one example, the apparatus further comprises a second beam coupled between a second side of the membrane and the substrate, the second side opposing the first side, and the second beam including a second stress sensor.

### BACKGROUND

An audio device, such as a microphone and a speaker, converts between mechanical energy (e.g., vibration) and electrical energy. An audio device can include a micro electromechanical system (MEMS) in which flaps are anchored along a perimeter and non-anchored parts of the flaps meet at a center. A region under the non-anchored parts forms a back volume for incident pressure to interact with the flaps. In the case of a microphone, the flaps can bend and generate stress responsive to the incident pressure (caused by incident sound waves), and the stress can be measured by transduction electrodes in the flaps. In the case of a speaker, the flaps can also bend responsive to electrical signals received by the transduction electrodes and generate pressure (and sound waves.

The lateral size and thickness of the flaps determine an area of the flaps that responds to the incident pressure and generates the stress. The lateral size and thickness of the flaps also determine the stiffness and the mass of the flaps, which in turn can affect various performance parameters of the audio device, such as sensitivity, resonance frequency, noise floor, and signal-to-noise ratio (SNR). These performance parameters are tightly coupled with direct tradeoff between them. For example, for good SNR performance, the flaps may be flexible and/or have a large area to generate a large stress (and a large signal from the transduction electrodes), but the increased flexibility and/or increased mass of the flap may reduce the resonance frequency such that the resonance frequency becomes closer to the audible frequency range, which degrades the frequency response of the audio device. In another instance, if the flaps are made smaller, the flaps can become much stiffer, resulting in significant loss in sensitivity and SNR.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a schematic illustrating a system including an audio device having flexible beams, in accordance with at least one example.

FIGS. 2A-D are schematics illustrating various views of a transducer device with flexible beams supporting a membrane, in accordance with at least some examples.

FIG. 3 is a schematic illustrating a top view of a transducer device with a stress profile, in accordance with at least one example.

FIG. 4 is a schematic illustrating a top view of a transducer device having flexible beams supporting a membrane, in accordance with at least one example.

FIG. 5 is a schematic illustrating a cross-sectional view of a transducer device having an extended shelf under a through opening, in accordance with at least one example.

FIG. 6 is a schematic illustrating a cross-sectional view of a transducer device with an extended shelf and edge walls on the flexible beams and a membrane, in accordance with at least one example.

FIGS. 7A, 7B, and 7C are schematics illustrating top views of a transducer device with edge walls, in accordance with at least some examples.

FIG. 8 is a schematic illustrating an array of transducer units, in accordance with at least one example.

FIGS. 9A, 9B, and 9C are schematics illustrating processing circuitries coupled to one or more transducer units, in accordance with at least some examples.

FIG. 10 is a schematic illustrating a cross-sectional view of a packaged integrated circuit (IC) with the array of transducer units, in accordance with at least one example.

FIG. 11 is a flowchart of a method of fabricating a transducer device, in accordance with at least one example.

### SUMMARY

In at least one example, an apparatus which comprises a substrate having a through opening; a membrane over the through opening and a first beam coupled between a first side of the membrane and the substrate. The apparatus further comprises a first beam including a first stress sensor or a first actuator. The apparatus further comprises a second beam coupled between a second side of the membrane and the substrate, the second side opposing the first side, and the second beam including a second stress sensor or a second actuator.

In at least one example, a packaged integrated circuit comprises a package substrate having a first through opening that aligns with a second through opening. The packaged integrated circuit further comprises a semiconductor die coupled to metal interconnects and an audio device on the package substrate. The audio device is coupled to the semiconductor die via the metal interconnects. In at least one example, the audio device comprises a semiconductor substrate mounted on the package substrate, the semiconductor substrate having the second through opening. The audio device further comprises a membrane over the second through opening. In at least one example, the audio device comprises a first beam coupled between a first side of the membrane and the semiconductor substrate, the first beam including a first stress sensor or a first actuator. In at least one example, the audio device comprises a second beam coupled between a second side of the membrane and the semiconductor substrate, the second side opposing the first side, and the second beam including a second stress sensor or a second actuator.

In at least one example, a method for fabricating an audio device comprises forming a through opening in a semiconductor substrate and forming a layer of piezoelectric bimorph on a dielectric material. The method further comprises patterning the layer of piezoelectric bimorph to form: a membrane over the through opening, a first beam coupled between a first side of the membrane and a first portion of the layer of piezoelectric bimorph on the substrate, and a second beam coupled between a second side of the membrane and a second portion of the layer of piezoelectric bimorph on the substrate, the second side opposing the first side.

In at least one example, an apparatus comprises a substrate having a through opening and a membrane over the through opening. In at least one example, the apparatus further comprises at least two piezoelectric beams coupled between the substrate and respective sides of the membrane such that the membrane is suspended over the through opening by the at least two piezoelectric beams.

### DETAILED DESCRIPTION

Disclosed herein is a transducer device or an audio device (e.g., a microphone) which comprises a substrate having a through opening and a membrane over the through opening. The audio device includes a first beam coupled between a first side of the membrane and the substrate, where the first beam includes a first stress sensor or a first actuator. The audio device further includes a second beam coupled between a second side of the membrane and the substrate, the second side opposing the first side, and the second beam includes a second stress sensor or a second actuator. The first and second beams are flexible beams providing a spring-like effect and support the membrane which behaves as a pressure plate. The first and second sensors or actuators include electrodes to provide signal to a processing circuitry coupled to the audio device. The membrane (and possibly the beams) interacts with incident pressure via the through opening and creates a force on the supporting first and second beams causing the beams to bend and generate a signal. Small portions of the first and second beams, respectively, compared to the entire size of the first and second beams are supporting the membrane. The rest of the beams are separated from the membrane by a gap. The size of the gap is configured to control the sensitivity of the transducer device. In at least one example, a shelf is formed under the first and second beams and a portion of the membrane to control vent resistance through the gap. While two beams are discussed here, the audio device can have an arbitrary number of supporting beams per membrane. The beam shape can also be optimized for stress concentration or transduction efficiency. Examples of beam shapes include rectangular, tapered, inverse tapered, curved, etc. In the case of a speaker, the first and second beams can include actuators that can cause the beams to bend or extend, which cause the membrane to create pressure and output sound waves via the through opening.

The membrane may comprise any suitable material. For instance, the membrane can be a bimorph piezoelectric stack like the ones used for the supporting first and second beams. In at least one example, the membrane may not include the full bimorph piezoelectric stack to reduce its mass and boost the resonance frequency. For instance, the membrane can comprise one of the layers of the bimorph piezoelectric stack forming a unimorph structure. In at least one example, a wall is formed around the transducer device to reduce the pressure leakage through the gap or slits defining the first and second beams and the membrane. The wall is orthogonal to the plane of the membrane. The thickness of the wall can be adjusted to modify the performance of the transducer device. In at least one example, additional walls can also be formed selectively on the first and second beams and/or the membrane at areas of large displacements.

An audio device with one membrane and supporting beams forms a transducer unit. In at least one example, a plurality of transducer units is arranged in an array, where each transducer unit may have a relatively small and stiff membrane. The higher stiffness results in a higher resonance frequency (and further away from audible frequency range), while the large number of array elements help increase the SNR, both of which are desirable. A large array of smaller transducer units with smaller membranes allows for maintaining higher resonance frequency, while generating sufficiently large volumetric displacement for efficient energy coupling. In at least one example, the through openings for the microphone units are formed by base die backside etching into smaller openings, which maintains the rigidity of the transducer device. In at least one example, the membranes in the array can be independently connected to implement self-test or self-equalization functionality. In the case of a microphone, the individual microphones can be connected in series to generate a higher voltage, or in parallel to generate a large current, both of which can lead to a larger output signal.

The examples discussed herein can provide various advantages. For instance, the area of the membrane, and hence the stress generated from the incident pressure, as well as the volumetric displacement of the membrane, can be independent from the stiffness of the beams. The configuration of the membrane and supporting beams allow flexibility in tuning the beam stiffness and shape, relatively independent of the actuation area of the membrane. Having an array of transducer units allows the membrane area of each unit to shrink without affecting the flexibility/stiffness of the beams, but because the output signals of the array of units are added, good sensitivity can still be maintained. The resulting smaller membrane and beams have less deflection for a given residual stress, and that helps to maintain the gaps and vents between the membrane, the beam, and a support base, which makes the lower cut-off frequency of the audio device more predictable. The configuration of the transducer device allows for more efficient use of the area in generating volumetric displacement for a given membrane area. The separation of the beams from the membrane allows the creation of a more flexible beam with a smaller size, while the resonance frequency can be controlled separately from the stiffness of the beams. For instance, the gaps between portions of the beams and the membranes allow for controlling stiffness and resonance frequency independently. The smaller opening under the membranes of the array helps with abrupt large pressure peaks (e.g., from shock, drops, etc.). Other technical effects will be evident from various examples described herein. Here, the same reference numbers or other reference designators are used in the drawings to designate the same or similar (either by function and/or structure) features.

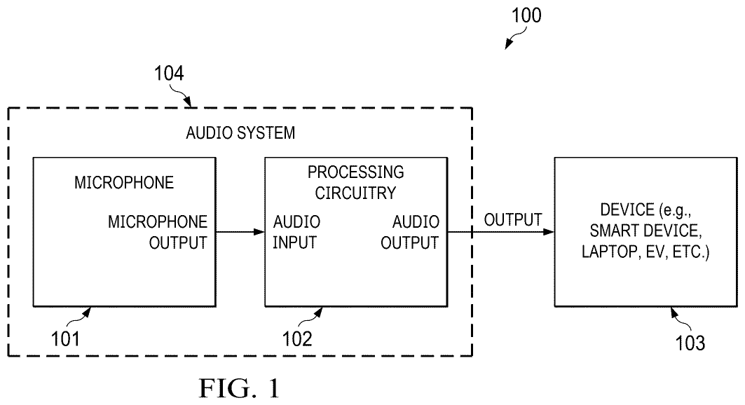

FIG. 1 is a schematic illustrating an audio system 100 having a microphone with flexible beams, in accordance with at least one example. Audio system 100 is an example of a transducer device 101, which may be a microphone in the example of FIG. 1. Audio system 100 may also comprise a processing circuit 102 and a device 103. Transducer device 101 and processing circuit 102 can be part of an audio system 104. In some examples, audio system 104 can be a packaged integrated circuit. In at least one example, transducer device 101 comprises a micro-electromechanical system (MEMS) or a nano-electromechanical system (NEMS) that converts mechanical energy from incident sound waves. Transducer device 101 can output an analog electrical signal on a microphone output to an audio input of processing circuit 102. In some examples, transducer device 101 can be a speaker or piezoelectric micro-machined ultrasound transducer (PMUT).

In at least one example, transducer device 101 comprises a substrate having a through opening and a membrane over the through opening and beams coupled between opposing sides of the membrane and the substrate. The beams include stress sensors (for a microphone) or actuators (for a speaker). The beams are flexible beams having a spring-like effect and support the membrane which behaves as a pressure plate. The electrodes in the beams sense (or generate) stress. In the case of a microphone, the electrodes can provide signals to processing circuit 102 representing the stress. In the case of a speaker, the electrodes can generate stress responsive to signals from processing circuit 102. The membrane (and possibly the beams) interacts with incident pressure (for a microphone) via the through opening and creates a force on the supporting beams causing the beams to bend and generate signals. For a speaker, the beams can move the membrane to generate pressure via the through opening. Small portions of the beams, compared to the entire size of the beams, support the membrane. The rest of the beams are separated from the membrane by a gap or a slit. The size of the gap is configured to control the lower cut-off frequency of transducer device 101. In at least one example, a shelf is formed under the beams and portions of the membrane to control vent resistance through the gap. The shape of the beams can also be optimized for stress concentration or transduction efficiency. Examples of beam shapes include rectangular, tapered, inverse tapered, curved, etc.

Transducer device 101 with one membrane and supporting beams forms a transducer unit. In at least one example, transducer device 101 includes a plurality of transducer units arranged in an array. In the case of a microphone, the electrodes of the individual transducer units can be connected in series to generate higher voltage, or in parallel to generate large current for processing circuit 102. The output from the plurality of transducer units of transducer device 101 can be coupled to an audio input of processing circuit 102 via a microphone output, or to an audio output of processing circuit 102 via a speaker input.

In the case of a microphone, the audio output of processing circuit 102 can be coupled to device 103 and can provide a processed audio output (e.g., digital signal representing audio sensed by transducer device 101) to device 103. In at least one example, processing circuit 102 comprises (or is part of) an integrated circuit (or a semiconductor die) which includes logic and or circuit to convert the audio input in an analog or acoustic domain (e.g., an analog signal) to the audio output in a digital domain or electrical domain (e.g., digital signal). Device 103 is any suitable device that uses the audio output from audio system 104. Examples of device 103 include a smart device, a smart phone, a tablet, an electric vehicle, a wearable device, a computer, etc.

In some examples, voice audio band for transducer device 101 is limited to 8 kHz. The resonance frequency can be anywhere above 8 kHz. The resonance usually has a limited quality factor (Q) and causes the sensitivity of transducer device 101 to increase before hitting the resonance, therefore it is moved further out from 8 kHz. In at least one example, the resonance is greater than 10 kHz or greater than 12 kHz. Higher resonance (e.g., greater than 12 kHz) may interfere with the non-linearity of a subsequent amplifier in processing circuit 102 and down converts audio frequency from around 10 kHz to the voice band. In some examples, the resonance of transducer device 101 is configured to be greater than 20 kHz (supersonic resonance). This allows for simple band limitation by the amplifier that immediately follows transducer device 101 and avoids such problems with non-linearity and mixing. The generic range for resonance is from 10 kHz up to 2 MHz (to cover ultrasound transducers). In at least one example, transducer device 101 has a resonance range from 14 kHz to 50 kHz.

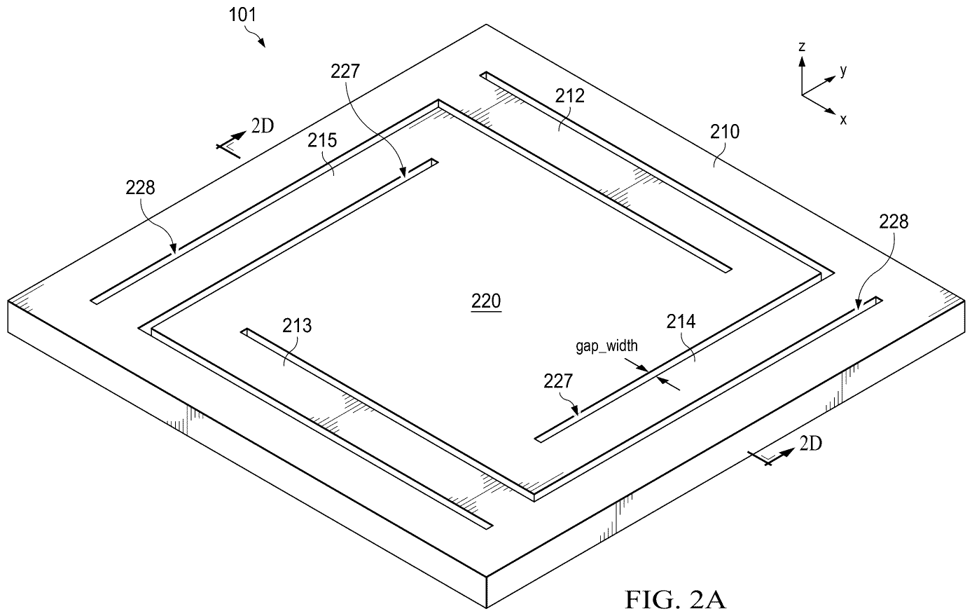

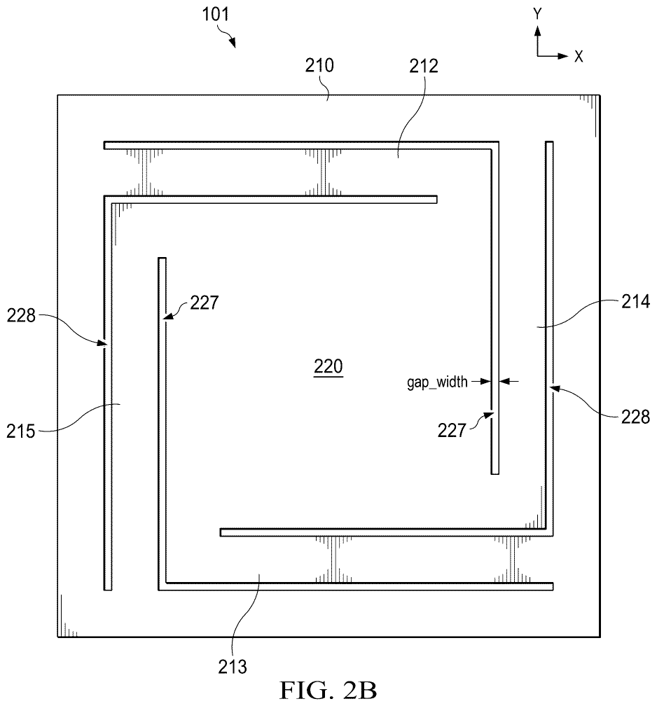

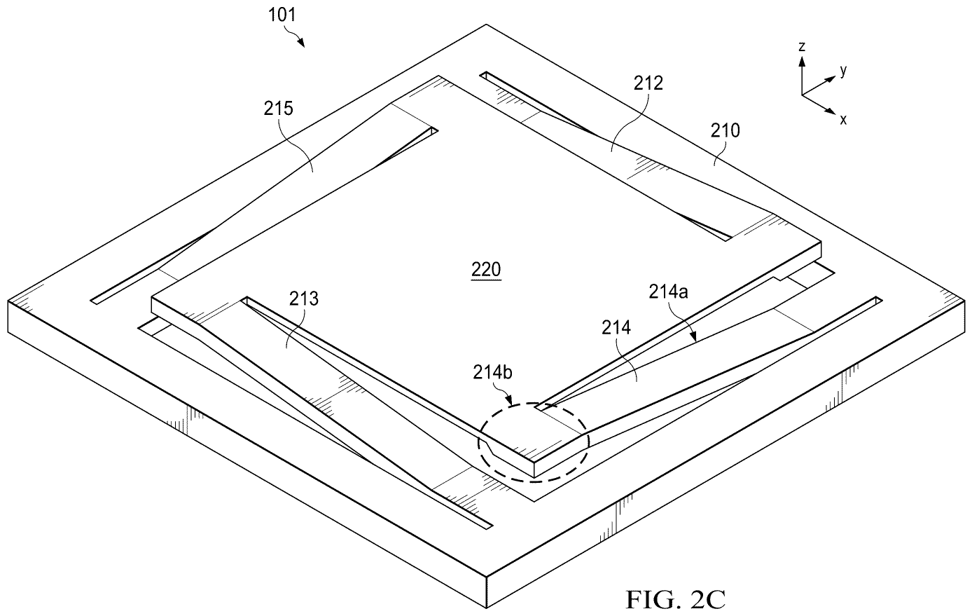

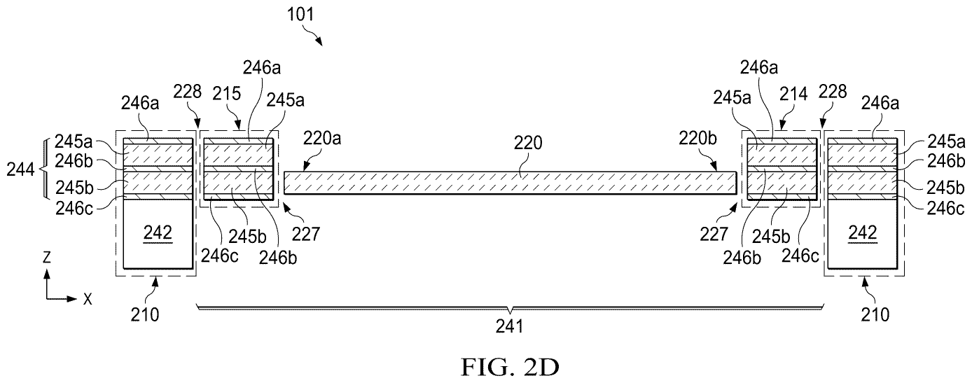

FIGS. 2A-D are schematics illustrating various views of transducer device 101 in accordance with at least some examples. FIG. 2A illustrates an isometric view of transducer device 101 having a membrane in a first position. FIG. 2B illustrates a plain view of transducer device 101 having the membrane in the first position. FIG. 2C illustrates an isometric view of transducer device 101 having a membrane in a second position. FIG. 2D illustrates a cross-sectional view of transducer device 101.

In at least one example, transducer device 101 comprises a boundary region 210 surrounding beams 212, 213, 214, and 215, and a membrane 220. Membrane 220 can be in a first position in FIG. 2A and FIG. 2B responsive to an incident pressure. One end of each beam is connected to membrane 220 while the opposite end of each beam is connected to boundary region 210. Inner gap 227 is between first sides of beams 212, 213, 214, and 215, and first and second sides 220a and 220b of membrane 220, respectively, while outer gap 228 is between second sides of beams 212, 213, 214, and 215, and boundary region 210. Here, the first position indicates compression of membrane 220 that causes beams 212, 213, 214, and 215 to be at the same lateral level as membrane 220. The separation of beams 212, 213, 214, and 215 from membrane 220 via gaps 227 and 228 allows the creation of a more compliant beam at smaller size, while giving independent control on the resonance frequency. In at least one example, gaps 227 and 228 have minimum widths (e.g., 0.5 μm to 1.5 μm). While four beams are discussed here, transducer device 101 can have an arbitrary number of supporting beams for membrane 220. The shape of beams 212, 213, 214, and 215 can also be optimized for stress concentration or transduction efficiency.

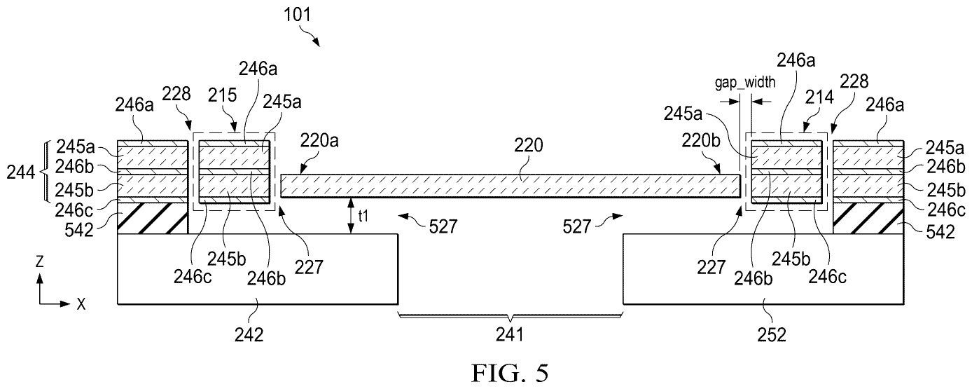

The width of gaps 227 and 228 can be reduced/minimized since gaps 227 and 228 represent leakage from front volume to back volume which bypasses membrane 220. Gaps 227 and 228 create a vent resistance, which together with the back volume creates a low-frequency cut-off (high-pass filter) for transducer device 101. In at least one example, the target lower cut-off frequency is lower than 100 Hz, and the size of the gap can be set based on the target lower cut-off frequency. The narrower the gap the better, from the perspective of vent resistance. The minimum width of the gap can be limited by various factors, such as lithography precision. Moreover, gaps 227 and 228 also represent viscous damping for the motion of membrane 220. A very narrow gap may also lead to additional noise due to the associated damping. The vent resistance and damping can be a function of gap_width\hat{ }3 and can also be linearly dependent on the thickness of membrane 220 and the length of the cuts for gap 227. In at least one example, the required width for gaps 227 and 228 to achieve a particular lower cut-off frequency can be significantly relaxed by implementing a shelf solution as discussed in FIG. 5.

FIG. 2C illustrates transducer device 101 having membrane 220 in a second position. Membrane 220 can be in the second position due, for example, to a very low (or zero) incident pressure on membrane 220, when beams 212, 213, 214, and 215 resort to their normal position like an uncompressed spring. Each beam includes two portions, where one portion is anchored to boundary region 210 while the other portion is connected to membrane 220. For instance, a first beam portion 214a of beam 214 is anchored to boundary region 210 while a second beam portion 214b of beam 214 is connected to a side of membrane 220.

FIG. 2D illustrates cross-section of transducer device 101 along a line illustrated in FIG. 2A. In at least one example, membrane 220 may comprise any suitable material. For instance, membrane 220 can be a bimorph piezoelectric stack like the ones used for the supporting beams 212, 213, 214, and 215. In at least one example, membrane 220 may not include the full bimorph piezoelectric stack to reduce its mass and boost the resonance frequency. For instance, membrane 220 can comprise one of the layers of the bimorph piezoelectric stack forming a unimorph structure.

In at least one example, beams 212, 213, 214, and 215 are MEMS or NEMS, which is fabricated within micron or nanometer dimensions, respectively. Certain MEMS or NEMS technologies may provide several benefits, such as batch fabrication that may lower manufacturing costs, small feature sizes, high resonant frequencies, and improved impedance matching.

In at least one example, a vertical stack of material for beams 212, 213, 214, and 215 includes a first piezoelectric material 245a, a second piezoelectric material 245b, a top electrode 246a, a middle electrode 246b, and a bottom electrode 246c. In at least one example, first piezoelectric material 245a and second piezoelectric material 245b comprise aluminum nitride (AlN). The thickness of AlN can be configured based on the target performance of the beam. For example, the thickness of AlN is substantially in a range of 200 nm to 500 nm to maximize SNR and sensitivity. While the examples are discussed with reference to AlN, any suitable piezoelectric material may be used. In at least one example, the electrodes (e.g., top electrode 246a, middle electrode 246b, and bottom electrode 246c) of a beam comprise molybdenum (Mo, or “moly,” or any other suitable material for electrodes). In at least one example, boundary region 210 may include a stack like the stack of material of beams 212, 213, 214, and 215 on substrate 242. For instance, boundary region 210 comprises a bimorph structure 244 having first piezoelectric material 245a, second piezoelectric material 245b, top electrode 246a, middle electrode 246b, and bottom electrode 246c. In another example, boundary region 210 comprises a unimorph structure where middle electrode 246b is removed and first and second piezoelectric material are merged as one material between top electrode 246a and bottom electrode 246c. Bottom electrode 246c may sit on a bulk or substrate 242 (e.g., silicon).

In some examples, first piezoelectric material 245a, second piezoelectric material 245b, top electrode 246a, middle electrode 246b, and bottom electrode 246c of a beam (e.g., beam 212, 213, 214, and 215) can form a stress sensor, in a case where transducer device 101 is a microphone. As membrane 220 causes the beam (and first piezoelectric material 245a and second piezoelectric material 245b) to bend and create stress, an electric field that corresponds to the stress can be created between top electrode 246a and middle electrode 246b, and between middle electrode 246b and bottom electrode 246c. The electrodes can generate a voltage (and/or a current) from the electric field, which can be measured by processing circuit 102. In a case where transducer device 101 is a speaker, first piezoelectric material 245a, second piezoelectric material 245b, top electrode 246a, middle electrode 246b, and bottom electrode 246c of a beam (e.g., beam 212, 213, 214, and 215) can form an actuator. Top electrode 246a, middle electrode 246b, and bottom electrode 246c can receive a signal and generate an electric field across first piezoelectric material 245a and second piezoelectric material 245b, which causes the beam to bend and displace membrane 220.

Membrane 220 is supported by first portions (e.g., 214a) of beams 212, 213, 214, and 215 over a through opening 241 (e.g., sound port). Beams 212, 213, 214, and 215 are flexible beams having a spring-like effect and support membrane 220 which behaves as a pressure plate or a piston. Top electrode 246 a, middle electrode 246 b, and/or bottom electrode 246 c in 212, 213, 214, and 215 provide signals to processing circuit 102. Membrane 220 (and possibly the beams) interacts with incident pressure via through opening 241 and creates a force/stress on supporting beams 212, 213, 214, and 215 causing beams 212, 213, 214, and 215 to bend and generate signals via top electrode 246a, middle electrode 246b, and/or bottom electrode 246c.

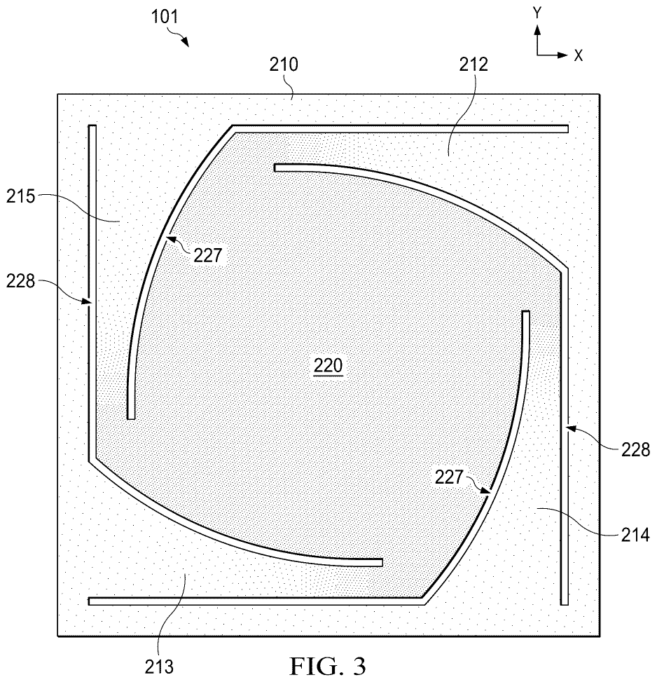

FIG. 3 is a schematic illustrating a top view of transducer device 101 with a stress profile, in accordance with at least one example. Compared to top view of FIG. 2B, here beams 212, 213, 214, and 215 have tapered shapes where a narrow portion of the beams is connected to membrane 220 while the broader portion of the beams is connected to boundary region 210. Here, the shade indicates stress intensity where darker shade is higher stress intensity and lighter shade is lower stress intensity. The tapered shapes for beams 212, 213, 214, and 215 create a uniform or constant stress through the beams to improve the electro-mechanical coupling, hence improving the sensitivity of the microphone unit and SNR.

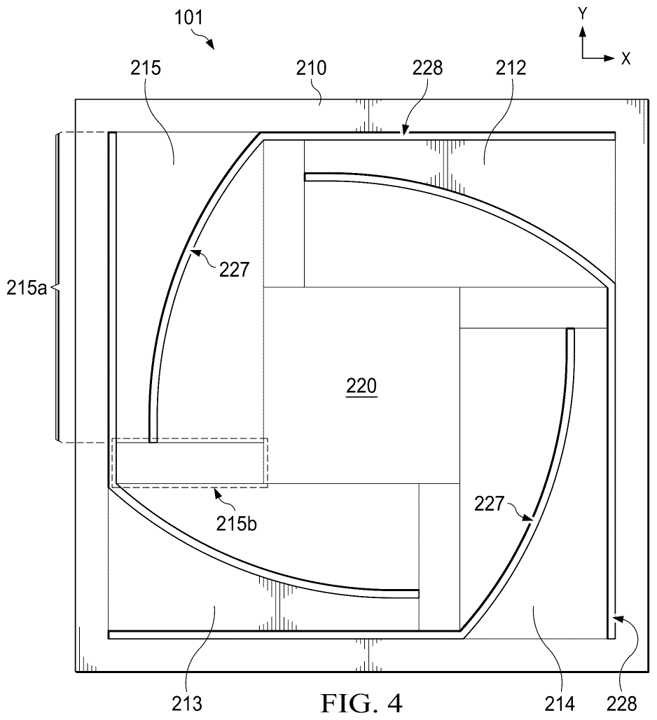

FIG. 4 is a schematic illustrating a top view of transducer device 101 where each flexible beam has at least two portions, in accordance with at least one example. Here, second beam portion 215b is orthogonal to first beam portion 215a, where second beam portion 215b connects to membrane 220 while first beam portion 215a connects to boundary region 210. In at least one example, first beam portion 215a is tapered with its wider part anchored to boundary region 210 and the narrower part connected to second beam portion 215b. One advantage of second beam portion 215b is that it provides more mechanical leverage and support for membrane 220 to actuate first beam portion 215a, especially in the case of membrane 220 being a single piezo layer or thinned down to reduce mass loading. Similarly, other beam shapes can be used to optimize stress concentration or transduction efficiency.

FIG. 5 is a schematic illustrating a cross-sectional view of a transducer device 101 with an extended shelf under a through opening of the microphone to control vent resistance, in accordance with at least one example. By extending bulk or substrate 242 towards through opening 241, a shelf 527 is created under first and second sides 220a and 220b of membrane 220. In at least one example, a spacer 552 is formed between bulk or substrate 242 to create shelf 527. Shelf 527 may have a height t1 according to the thickness of spacer 542. Shelf 527 provides an avenue for pressure to route away from membrane 220. Adjusting height t1 can control vent resistance irrespective of lithography precision. As such, the vent resistance can be a function of the vertical separation t1 between membrane 220 and the surrounding shelf, relaxing the constraint on the lateral gap_width. In at least one example, shelf 527 is formed by wet etching a sacrificial layer under the beams and membrane 220.

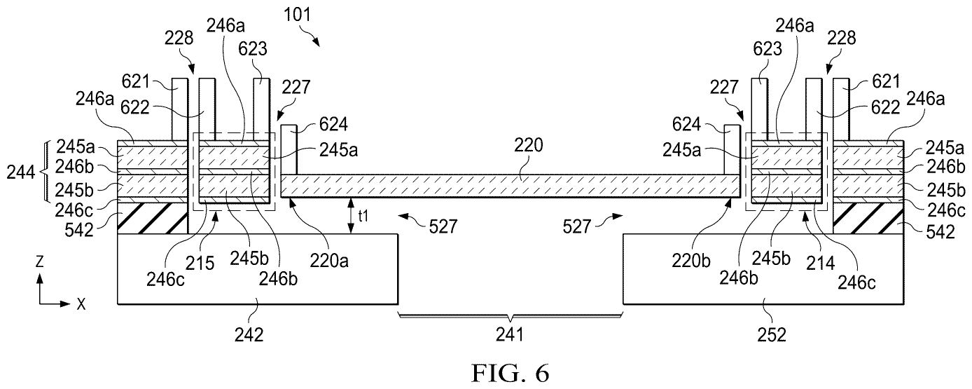

FIG. 6 is a schematic illustrating a cross-sectional view of transducer device 101 with an extended shelf and edge walls on the flexible beams and membrane of transducer device 101, in accordance with at least one example. In at least one example, a wall 621 is formed around transducer device 101 on boundary region 210. In at least one example, walls 622 and 623 can also be formed selectively on beams 212, 213, 214, and 215 at areas of large displacements. A wall 624 can also be formed on first and second sides 220a and 220b of membrane 220, respectively. Walls 621, 622, 623, and 624 reduce the pressure leakage through gaps or slits 227 and 228. The thickness and/or height of the walls 621, 622, 623, and 624 can be adjusted to modify the performance of transducer device 101. Any suitable material may be used for forming walls 621, 622, 623, and 624 that is sufficiently thick and precisely deposited at locations shown. For instance, walls 621, 622, 623, and 624 may comprise the same material as membrane 220, or may comprise silicon.

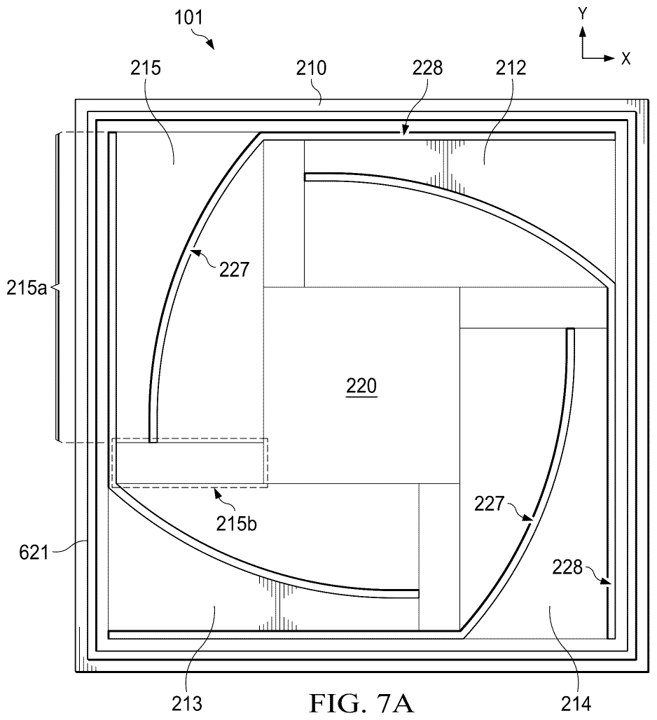

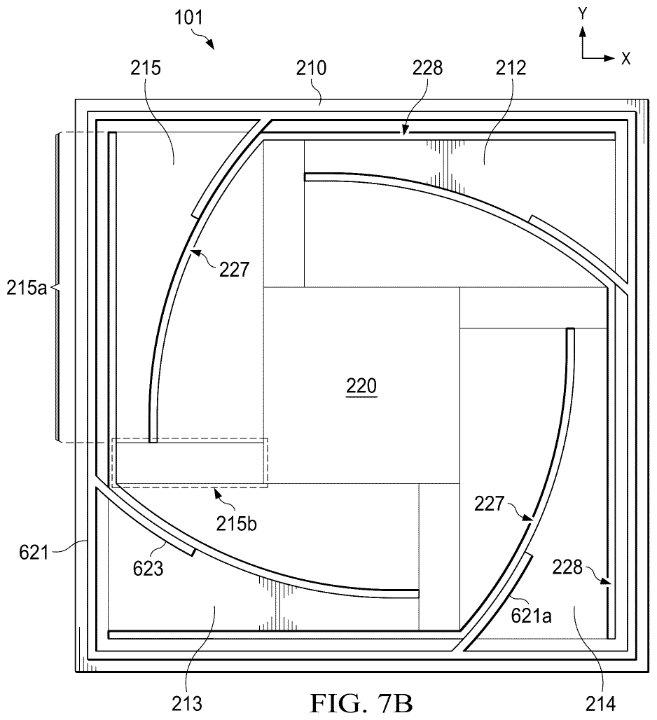

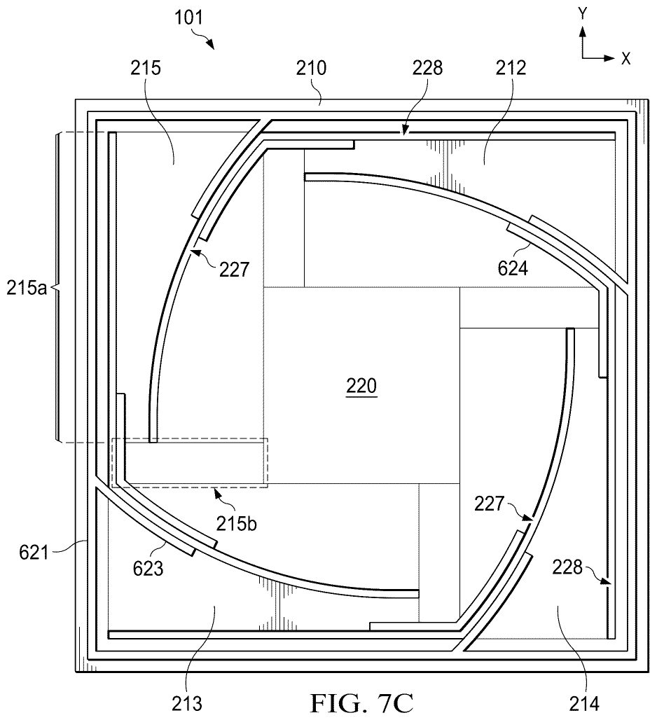

FIGS. 7A-C are schematics illustrating top views of transducer device 101 with edge walls, respectively, in accordance with at least some examples. FIG. 7A illustrates a top view of transducer device 101 with wall 621 formed over boundary region 210 along the edge of gap 228. FIG. 7B illustrates a top view of transducer device 101 with wall 621 formed over boundary region 210 along the edge of gap 228 and wall 623 partially along beams 212, 213, 214, and 215 next to gap 227. FIG. 7C illustrates a top view of transducer device 101 with wall 621 formed over boundary region 210 along the edge of gap 228, wall 623 partially along beams 212, 213, 214, and 215 next to gap 227, and wall 624 partially along first and second sides 220a, 220b of membrane 220 next to gap 227. Wall 623 is at the location of maximum displacement of membrane 220.

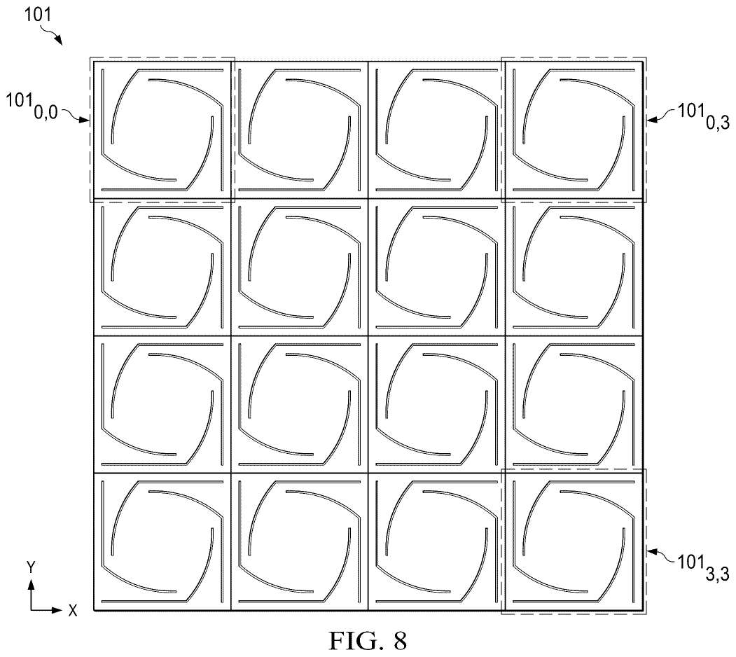

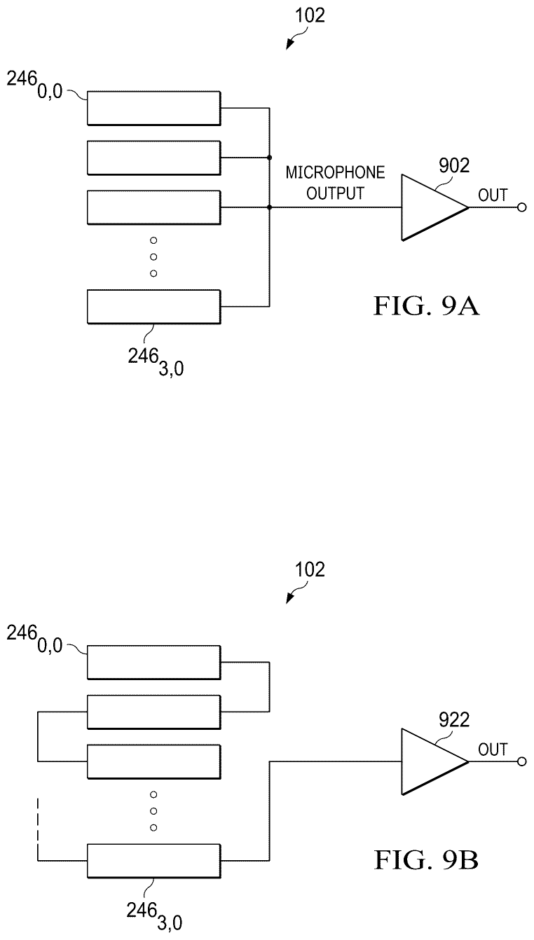

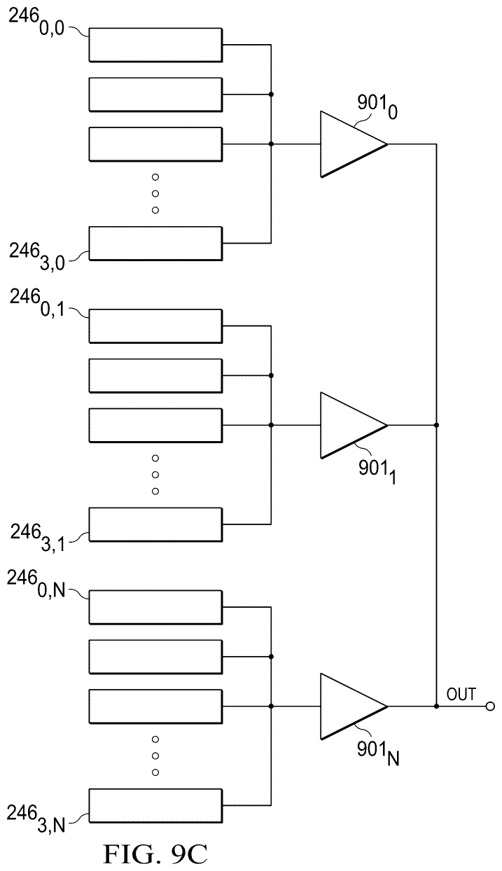

FIG. 8 is a schematic illustrating an array of transducer units (e.g., microphone units), in accordance with at least one example. As discussed herein, a transducer device with one membrane and supporting beams forms a transducer unit. In at least one example, transducer units 101_{0,0} through 101_{N,M} (where N and M are numbers greater than 0) are arranged in an array. Here, a 4×4 array is shown, but any size can be used to form transducer device 101. Each transducer unit can have a smaller membrane, which can increase the stiffness of the membrane. The higher stiffness results in higher resonance frequency, while the large number of microphone units helps increase the SNR. Compared with a transducer device 101 with a single membrane having the same total area of the membranes of the N×M transducer units, an array of transducer units allows for maintaining higher resonance frequency while generating similar volumetric displacement for efficient energy coupling. In at least one example, the different membranes in the array can be independently connected to implement self-test or self-equalization functionality. The individual transducer devices can be connected in series (to generate higher voltage), or in parallel to generate large current as shown in FIGS. 9A-C.

FIGS. 9A-C are schematics illustrating processing circuitries coupled to one or more transducer units, in accordance with at least some examples. FIG. 9A illustrates electrodes (e.g., electrodes 246_{0,0} through 246_{3,0}) coupled in parallel to charge amplifier 902. In the case of using charge amplifier 902 (an amplifier that presents close to 0 Ω input impedance and depletes all the current from attached microphone array), electrodes of transducer units of the array are connected in parallel. FIG. 9B illustrates electrodes (e.g., electrodes 246_{0,0} through 246_{3,0}) coupled in series to voltage amplifier 922. In at least one example, voltage amplifier 922 is a low noise amplifier. In the case of using voltage amplifier 922 (an amplifier with very high input impedance that amplifies input voltage), electrodes of the transducer units of the array are connected in series to achieve larger output voltage from the array. Electrodes 246_{0,0} through 246_{3,0} can be top, bottom, or middle electrodes.

FIG. 9C illustrates a configuration where a plurality of charge amplifiers 901₀ through 901_{N} are coupled to columns or rows of the array including electrodes 246_{0,0} through 246_{3,N}. Outputs of plurality of charge amplifiers 901₀ through 901_{N} are summed at node Out. The series or parallel connection of electrodes to the amplifier can mitigate parasitic capacitance at the input of the amplifier. In at least one example, charge amplifiers 901₀ through 901_{N} are removed and charge or current from columns or rows of the array are summed at node Out.

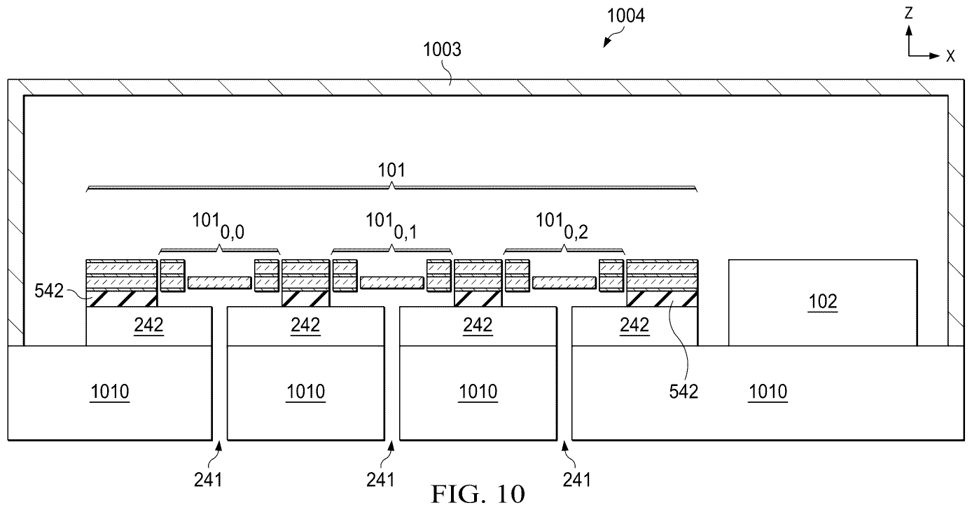

FIG. 10 is a schematic illustrating a cross-sectional view of packaged integrated circuit (IC) 1004 with an array of transducer units, in accordance with at least one example. In at least one example, the through openings for the microphone units are made by base die backside etching into smaller openings, which maintains the rigidity of the transducer device. Packaged IC 1004 can include, for example, audio system 104. Packaged IC 1004 comprises package substrate 1010, casing 1003, transducer units 101_{0,0}, 101_{0,1}, and 101_{0,2} forming a transducer array (e.g., a microphone array, a speaker array, etc.), and an IC (e.g., processing circuit 102). Through openings 241 formed in substrate 242 are also formed in package substrate 1010. In at least one example, backside etching of substrate 242 is divided into smaller openings 241, which maintains the rigidity of the silicon die of audio system 104.

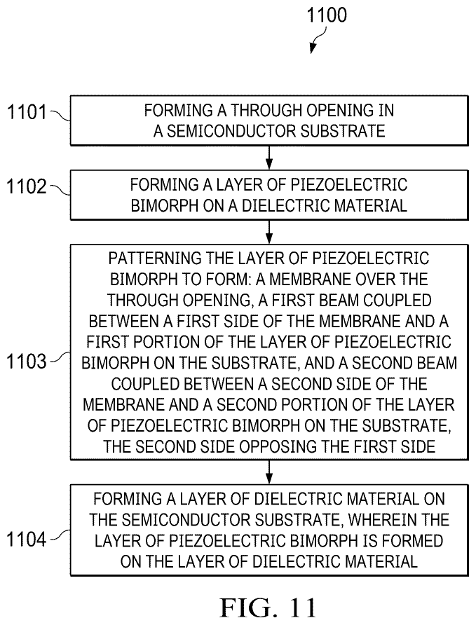

FIG. 11 is a flowchart 1100 of a method of fabricating a transducer device, such as transducer device 101, in accordance with at least one example. At block 1101, through opening 241 is formed in semiconductor substrate 242 through backside etching. At block 1102, a stack of layers is deposited forming a layer of piezoelectric bimorph on a dielectric material (e.g., spacer 542) and/or substrate 242. The stack of layers includes first piezoelectric material 245a, second piezoelectric material 245b, top electrode 246a, middle electrode 246b, and bottom electrode 246c. At block 1103, the stack of layers of piezoelectric bimorph is patterned to membrane 220 over through opening 241, and beams 212, 213, 214, and 215 coupled between first and second sides 220a and 220b of membrane 220 and a first portion of the stack of layers of piezoelectric bimorph on substrate 242. In at least one example, the stack of layers of piezoelectric bimorph is patterned to form first and second gaps 227 and 228 between beams 212, 213, 214, and 215 and boundary region 210 and between beams 212, 213, 214, and 215 and first and second sides 220a and 220b of membrane 220. At block 1104, a layer of spacer 542 is formed on semiconductor substrate 242, wherein stack of layers of piezoelectric bimorph is formed on the layer of spacer 542. In at least one example, shelf 527 is formed under membrane 220 and beams 212, 213, 214, and 215 by removing a part of layer of spacer 542 between the surface of semiconductor substrate 242 and membrane 220. For example, wet etching is performed on a sacrificial layer under membrane 220 and beams 212, 213, 214, and 215 to form an opening (a shelf) of height t1.

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.

Example 1 is an apparatus comprising: a substrate having a through opening; a membrane over the through opening; a first beam coupled between a first side of the membrane and the substrate, the first beam including a first stress sensor or a first actuator; and a second beam coupled between a second side of the membrane and the substrate, the second side opposing the first side, and the second beam including a second stress sensor or a second actuator.

Example 2 is an apparatus according to any example herein, in particular example 1, wherein the first stress sensor is configured to sense at least one of a compressive stress or a tensile stress in the first beam caused by a movement of the membrane with respect to the through opening, and the second stress sensor is configured to sense at least one of a compressive stress or a tensile stress in the second beam caused by the movement of the membrane.

Example 3 is an apparatus according to any example herein, in particular example 2, wherein the first beam includes a first piezoelectric bimorph configured as the first stress sensor or the first actuator, and the second beam includes a second piezoelectric bimorph configured as the second stress sensor or the second actuator.

Example 4 is an apparatus according to any example herein, in particular example 1, wherein the first beam has a first beam portion that extends from the substrate along the first side of the membrane, and a second beam portion angled from the first beam portion and coupled between the first beam portion and the first side of the membrane; and wherein the second beam has a third beam portion that extends from the substrate along the second side of the membrane, and a fourth beam portion angled from the third beam portion and coupled between the third beam portion and the second side of the membrane.

Example 5 is an apparatus according to any example herein, in particular example 4, wherein the first beam portion tapers from the substrate towards the second beam portion, and the third beam portion tapers from the substrate towards the fourth beam portion.

Example 6 is an apparatus according to any example herein, in particular example 1, further comprising a layer of material on the substrate, the first beam being spaced from the layer by a first gap, the second beam being spaced from the layer by a second gap, at least part of the first beam being spaced from the first side of the membrane by a third gap, and at least part of the second beam being spaced from the second side of the membrane by a fourth gap.

Example 7 is an apparatus according to any example herein, in particular example 6, wherein the first, second, third, and fourth gaps have a uniform width.

Example 8 is an apparatus according to any example herein, in particular example 7, wherein the membrane and the first and second beams are configured as an audio device, and the width is based on a target frequency response of the audio device.

Example 9 is an apparatus according to any example herein, in particular example 8, wherein the width is based on a target lower cutoff frequency of the audio device.

Example 10 is an apparatus according to any example herein, in particular example 6, wherein each of the first beam includes a first piezoelectric bimorph, the second beam includes a second piezoelectric bimorph, the layer of material includes a third piezoelectric bimorph or a first piezoelectric unimorph, and the membrane includes a fourth piezoelectric bimorph or a second piezoelectric unimorph.

Example 11 is an apparatus according to any example herein, in particular example 6, wherein the substrate has a surface that extends below and parallel with the membrane, and the through opening is smaller than the membrane.

Example 12 is an apparatus according to any example herein, in particular example 11, wherein the layer of material is a first layer of a first material, and the apparatus further comprises a second layer of a second material between the substrate and the first layer of the first material, and wherein a thickness of the second layer defines a gap between the membrane and the surface of the substrate.

Example 13 is an apparatus according to any example herein, in particular example 12, wherein the membrane and the first and second beams are configured as an audio device, and the thickness or a height of the gap is based on a target lower cutoff frequency of the audio device.

Example 14 is an apparatus according to any example herein, in particular example 12, wherein the second material includes a dielectric material.

Example 15 is an apparatus according to any example herein, in particular example 6, further comprising at least one of a first wall structure along the first gap, a second wall structure along the second gap, a third wall structure along the third gap, or a fourth wall structure along the fourth gap, the at least one of the first, second, third, or fourth wall structures being on at least one of the layer of material, the first beam, the second beam, or the membrane.

Example 16 is an apparatus according to any example herein, in particular example 1, wherein the first and second beams, the first and second sensors, and the membrane form a microphone unit, and the apparatus includes an array of the microphone units.

Example 17 is an apparatus according to any example herein, in particular example 16, further comprising a processing circuit coupled to sensor outputs of the array of the microphone units, the processing circuit configured to provide an audio signal representing sound waves detected by the microphone units by combining sensor signals at the sensor outputs of the array of the microphone units.

Example 18 is an apparatus according to any example herein, in particular example 1, wherein the substrate is a semiconductor substrate, the through opening is a first through opening, and the semiconductor substrate, the first and second beams, and the membrane are part of a packaged integrated circuit, the packaged integrated circuit further comprises: a package substrate having a second through opening that aligns with the first through opening, the semiconductor substrate being mounted on the package substrate; a semiconductor die including a processing circuit; metal interconnects coupled between the semiconductor die and the first and second beams; and a cap covering the membrane, the first and second beams, the semiconductor die, and the metal interconnects.

Example 19 is a packaged integrated circuit comprising: a package substrate having a first through opening that aligns with a second through opening; a semiconductor die coupled to metal interconnects; and a transducer on the package substrate, the transducer coupled to the semiconductor die via the metal interconnects, wherein the transducer comprises: a semiconductor substrate being mounted on the package substrate, the semiconductor substrate having the second through opening; a membrane over the second through opening; a first beam coupled between a first side of the membrane and the semiconductor substrate, the first beam including a first stress sensor or a first actuator; and a second beam coupled between a second side of the membrane and the semiconductor substrate, the second side opposing the first side, and the second beam including a second stress sensor or a second actuator.

Example 20 is a packaged integrated circuit according to any example herein, in particular example 19, wherein the first stress sensor is configured to sense at least one of a compressive stress or a tensile stress in the first beam caused by a movement of the membrane with respect to the second through opening, and the second stress sensor is configured to sense at least one of a compressive stress or a tensile stress in the second beam caused by the movement of the membrane.

Example 21 is a packaged integrated circuit according to any example herein, in particular example 20, wherein the first beam includes a first piezoelectric bimorph configured as the first stress sensor or the first actuator, and the second beam includes a second piezoelectric bimorph configured as the second stress sensor or the second actuator.

Example 22 is a packaged integrated circuit according to any example herein, in particular example 19, wherein the first beam has a first beam portion that extends from the substrate along the first side of the membrane, and a second beam portion angled from the first beam portion and coupled between the first beam portion and the first side of the membrane; and wherein the second beam has a third beam portion that extends from the substrate along the second side of the membrane, and a fourth beam portion angled from the third beam portion and coupled between the third beam portion and the second side of the membrane.

Example 23 is a packaged integrated circuit according to any example herein, in particular example 22, wherein the first beam portion tapers from the substrate towards the second beam portion, and the third beam portion tapers from the substrate towards the fourth beam portion.

Example 24 is a method comprising: forming a through opening in a semiconductor substrate; forming a layer of piezoelectric bimorph on a dielectric material; and patterning the layer of piezoelectric bimorph to form: a membrane over the through opening, a first beam coupled between a first side of the membrane and a first portion of the layer of piezoelectric bimorph on the substrate, and a second beam coupled between a second side of the membrane and a second portion of the layer of piezoelectric bimorph on the substrate, the second side opposing the first side.

Example 25 is a method according to any example herein, in particular example 24, wherein patterning the layer of piezoelectric bimorph includes: patterning the layer of piezoelectric bimorph to form a first gap between the first beam and the first portion of the layer of piezoelectric bimorph, a second gap between the second beam and the second portion of the layer of piezoelectric bimorph, a third gap between the first beam and the first side of the membrane, and a fourth gap between the second beam and the second side of the membrane.

Example 26 is a method according to any example herein, in particular example 24, wherein the first, second, third, and fourth gaps have a uniform width.

Example 27 is a method according to any example herein, in particular example 24, further comprising forming a layer of dielectric material on the semiconductor substrate, wherein the layer of piezoelectric bimorph is formed on the layer of dielectric material.

Example 28 is a method according to any example herein, in particular example 26, wherein the semiconductor substrate has a surface that extends below and parallel with the membrane, the through opening is smaller than the membrane, and the method further comprising removing a part of the layer of dielectric material between the surface of the semiconductor substrate and membrane.

Example 29 is an apparatus comprising: a substrate having a through opening; a membrane over the through opening; and at least two piezoelectric beams coupled between the substrate and respective sides of the membrane such that the membrane is suspended over the through opening by the at least two piezoelectric beams.

Example 30 is an apparatus according to any example herein, in particular example 29, wherein the at least two piezoelectric beams are configured to sense at least one of a compressive stress or a tensile stress in the at least two piezoelectric beams caused by a movement of the membrane with respect to the through opening.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor components.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be in depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a substrate having a through opening;
a membrane over the through opening;
a first beam coupled between a first side of the membrane and the substrate, the first beam including a first stress sensor or a first actuator; and
a second beam coupled between a second side of the membrane and the substrate, the second side opposing the first side, and the second beam including a second stress sensor or a second actuator.

2. The apparatus of claim 1, wherein the first stress sensor is configured to sense at least one of a compressive stress or a tensile stress in the first beam caused by a movement of the membrane with respect to the through opening, and the second stress sensor is configured to sense at least one of a compressive stress or a tensile stress in the second beam caused by the movement of the membrane.

3. The apparatus of claim 2, wherein the first beam includes a first piezoelectric bimorph configured as the first stress sensor or the first actuator, and the second beam includes a second piezoelectric bimorph configured as the second stress sensor or the second actuator.

4. The apparatus of claim 1, wherein the first beam has a first beam portion that extends from the substrate along the first side of the membrane, and a second beam portion angled from the first beam portion and coupled between the first beam portion and the first side of the membrane; and
wherein the second beam has a third beam portion that extends from the substrate along the second side of the membrane, and a fourth beam portion angled from the third beam portion and coupled between the third beam portion and the second side of the membrane.

5. The apparatus of claim 4, wherein the first beam portion tapers from the substrate towards the second beam portion, and the third beam portion tapers from the substrate towards the fourth beam portion.

6. The apparatus of claim 1, further comprising a layer of material on the substrate, the first beam being spaced from the layer by a first gap, the second beam being spaced from the layer by a second gap, at least part of the first beam being spaced from the first side of the membrane by a third gap, at least part of the second beam being spaced from the second side of the membrane by a fourth gap.

7. The apparatus of claim 6, wherein the first, second, third, and fourth gaps have a uniform width.

8. The apparatus of claim 7, wherein the membrane and the first and second beams are configured as an audio device, and the width is based on a target frequency response of the audio device.

9. The apparatus of claim 8, wherein the width is based on a target lower cutoff frequency of the audio device.

10. The apparatus of claim 6, wherein the first beam includes a first piezoelectric bimorph, the second beam includes a second piezoelectric bimorph, the layer of material includes a third piezoelectric bimorph or a first piezoelectric unimorph, and the membrane includes a fourth piezoelectric bimorph or a second piezoelectric unimorph.

11. The apparatus of claim 6, wherein the substrate has a surface that extends below and parallel with the membrane, and the through opening is smaller than the membrane.

12. The apparatus of claim 11, wherein the layer of material is a first layer of a first material, and the apparatus further comprises a second layer of a second material between the substrate and the first layer of the first material, and wherein a thickness of the second layer defines a gap between the membrane and the surface of the substrate.

13. The apparatus of claim 12, wherein the membrane and the first and second beams are configured as an audio device, and the thickness or a height of the gap is based on a target lower cutoff frequency of the audio device.

14. The apparatus of claim 12, wherein the second material includes a dielectric material.

15. The apparatus of claim 6, further comprising at least one of a first wall structure along the first gap, a second wall structure along the second gap, a third wall structure along the third gap, or a fourth wall structure along the fourth gap, the at least one of the first, second, third, or fourth wall structures being on at least one of the layers of material, the first beam, the second beam, or the membrane.

16. The apparatus of claim 1, wherein the first and second beams, the first and second sensors, and the membrane form a microphone unit, and the apparatus includes an array of the microphone units.

17. The apparatus of claim 16, further comprising a processing circuit coupled to sensor outputs of the array of the microphone units, the processing circuit configured to provide an audio signal representing sound waves detected by the microphone units by combining sensor signals at the sensor outputs of the array of the microphone units.

18. The apparatus of claim 1, wherein the substrate is a semiconductor substrate, the through opening is a first through opening, and the semiconductor substrate, the first and second beams, and the membrane are part of a packaged integrated circuit, the packaged integrated circuit further comprises:
a package substrate having a second through opening that aligns with the first through opening, the semiconductor substrate being mounted on the package substrate;
a semiconductor die including a processing circuit;
metal interconnects coupled between the semiconductor die and the first and second beams; and
a cap covering the membrane, the first and second beams, the semiconductor die, and the metal interconnects.

19. A packaged integrated circuit comprising:
a package substrate having a first through opening that aligns with a second through opening;
a semiconductor die coupled to metal interconnects; and
a transducer on the package substrate, the transducer coupled to the semiconductor die via the metal interconnects, wherein the transducer comprises:
a semiconductor substrate being mounted on the package substrate, the semiconductor substrate having the second through opening;
a membrane over the second through opening;
a first beam coupled between a first side of the membrane and the semiconductor substrate, the first beam including a first stress sensor or a first actuator; and
a second beam coupled between a second side of the membrane and the semiconductor substrate, the second side opposing the first side, and the second beam including a second stress sensor or a second actuator.

20. The packaged integrated circuit of claim 19, wherein the first stress sensor is configured to sense at least one of a compressive stress or a tensile stress in the first beam caused by a movement of the membrane with respect to the second through opening, and the second stress sensor is configured to sense at least one of a compressive stress or a tensile stress in the second beam caused by the movement of the membrane.

21. The packaged integrated circuit of claim 20, wherein the first beam includes a first piezoelectric bimorph configured as the first stress sensor or the first actuator, and the second beam includes a second piezoelectric bimorph configured as the second stress sensor or the second actuator.

22. The packaged integrated circuit of claim 19, wherein the first beam has a first beam portion that extends from the substrate along the first side of the membrane, and a second beam portion angled from the first beam portion and coupled between the first beam portion and the first side of the membrane; and
wherein the second beam has a third beam portion that extends from the substrate along the second side of the membrane, and a fourth beam portion angled from the third beam portion and coupled between the third beam portion and the second side of the membrane.

23. The packaged integrated circuit of claim 22, wherein the first beam portion tapers from the substrate towards the second beam portion, and the third beam portion tapers from the substrate towards the fourth beam portion.

24. A method comprising:
forming a through opening in a semiconductor substrate;
forming a layer of piezoelectric bimorph on a dielectric material; and
patterning the layer of piezoelectric bimorph to form: a membrane over the through opening, a first beam coupled between a first side of the membrane and a first portion of the layer of piezoelectric bimorph on the substrate, and a second beam coupled between a second side of the membrane and a second portion of the layer of piezoelectric bimorph on the substrate, the second side opposing the first side.

25. The method of claim 24, wherein patterning the layer of piezoelectric bimorph includes: patterning the layer of piezoelectric bimorph to form a first gap between the first beam and the first portion of the layer of piezoelectric bimorph, a second gap between the second beam and the second portion of the layer of piezoelectric bimorph, a third gap between the first beam and the first side of the membrane, and a fourth gap between the second beam and the second side of the membrane.

26. The method of claim 24, wherein the first, second, third, and fourth gaps have a uniform width.

27. The method of claim 24, further comprising forming a layer of dielectric material on the semiconductor substrate, wherein the layer of piezoelectric bimorph is formed on the layer of dielectric material.

28. The method of claim 26, wherein the semiconductor substrate has a surface that extends below and parallel with the membrane, the through opening is smaller than the membrane, and the method further comprising removing a part of the layer of dielectric material between the surface of the semiconductor substrate and membrane.

29. An apparatus comprising:
a substrate having a through opening;
a membrane over the through opening; and
at least two piezoelectric beams coupled between the substrate and respective sides of the membrane such that the membrane is suspended over the through opening by the at least two piezoelectric beams.

30. The apparatus of claim 29, wherein the at least two piezoelectric beams are configured to sense at least one of a compressive stress or a tensile stress in the at least two piezoelectric beams caused by a movement of the membrane with respect to the through opening.
